(19) United States
(12) Patent Application Publication
(10) Pub. No.: US 2009/0136015 A1
(43) Pub. Date: May 28, 2009

(54) INCOMING CALL CHALLENGER

(76) Inventor: Eric Roberts, Shanghai (CN)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(21) Appl. No.: 11/944,883

(22) Filed: Nov. 26, 2007

(51) Int. Cl. H04M 3/42

(52) U.S. Cl. 379/210.02

(57) ABSTRACT

In one embodiment, a method of challenging an incoming call to a called party based on predetermined call challenge rules. The call challenge rules may include challenging a calling party when an incoming call falls within a call challenge time window of the local time of the called party. A method may include determining the local time of the called party, announcing the local time to the calling party, and prompting the calling party whether to ring the ringer of the called party or be routed to voicemail.

### FIELD OF THE INVENTION

The present invention relates generally to the field of telecommunications, and more specifically, to telephone system features.

### BACKGROUND

There are many different types of telephone systems, such as traditional telephone systems, generally referred to as Plain Old Telephone Service (POTS) systems, cellular telephone systems that provide connections by various radio frequency protocols, and modern packet-switching telephone systems that utilize Voice over Internet Protocol (VoIP) technology. In each of these systems, when an incoming call is received by a called party, a ringer of the called party's telephone is rung to alert the called party of the incoming call. The ringer continues to ring until the called party answers, the calling party hangs up, or the call is routed to voice mail or an answering machine.

### OVERVIEW

In one example method, prior to ringing a ringer of a called party, an incoming call may be challenged based upon predetermined call challenge rules. The call challenge rules may be based upon the local time of the called party or other criteria. For example, the call challenge rules may stipulate that incoming calls that occur during a predetermined call challenge time window are to be challenged. In an example method, when an incoming call is received, the local time of the called party is determined and a determination is made whether the call falls within the predetermined call challenge time window specified by the call challenge rules. If the call does fall within the challenge window, then, prior to ringing the called party's ringer, the calling party is notified of the called party's local time and prompted whether to ring the called party's ringer or route the call to voice mail. The call may then be routed to ring the called party's ringer or routed to voice mail in accordance with the calling party's response. This allows the called party to efficiently screen incoming calls during designated time periods by ringing the ringer of the called party for important calls and not ringing the ringer for unimportant calls during designated time frames, such as sleeping hours.

In one example embodiment, a Call Challenge Module (CCM) is used to challenge incoming calls. The CCM may communicate with a call manager of the called party's existing telephone system to challenge incoming calls. For example, the CCM can be coupled to a Media Terminal Adapter (MTA), Voice over Internet Protocol (VoIP) adapter or similar device that manages calls of the called party. The CCM may instruct the call manager to challenge an incoming call, prompt the calling party to specify a desired action, receive the calling party's response, and perform an action in accordance with the calling party's response. By communicating with the call manager, the enhanced call challenge features can be implemented at the called party without necessitating changes to the called party's network or changes by the called party's telephony service providers.

In one example embodiment, a CCM may include a determination module to communicate with a call manager of the called party and determine whether to challenge an incoming call, a prompt module for challenging the incoming call, and a user interface for establishing the rules by which calls are challenged. The determination module may include a memory for storing call challenge rules and a processor for executing actions in accordance with the call challenge rules, such as sending instructions to the call manager device to query a time server on a network to obtain the local time of the called party, to route the call to voice mail, or to ring the called party's ringer. The prompt module may include an automated response means such as a voice generator, voice recognition software and other components to generate a voice message to prompt the calling party and receive the calling party's response. While shown in some figures as separate modules, the functions of the determination module and prompt module may be performed by a single module or incorporated directly into components of the call manager.

The CCM may also include a user interface to provide a called party with the ability to activate and deactivate the CCM and to view, update, and change the call challenge rules. For example, a web server may be used to generate a web page by which a user can establish the call challenge rules. The call challenge rules may include various criteria for determining whether to challenge incoming calls, such as, the local time of the called party, the identity of the calling party, the area code of the calling party, the day of the week, etc.

In one example embodiment, the CCM may be incorporated into a call manager device such as an MTA or VoIP adapter, to provide a call challenge-enabled communication device. In this case, the CCM may use components of the call manager, such as the call manager's memory and processor, to provide call challenge functions. In one example embodiment, a call challenge enabled-communication device takes the form of a call challenge-enabled MTA (CCMTA) that includes a CCM, a modem, and a VoIP adapter for use with a cable network. In another example embodiment, a call challenge-enabled device is in the form of a call challenge-enabled VoIP adapter (CCVA). The CCM may also be incorporated into other apparatus and systems such as a program guide used in conjunction with a cable set-top box. The CCM of these devices determines whether the incoming call falls within the challenge rules, and if so, challenges the calling party prior to ringing the ringer of the telephone, prompts the calling party to specify a desired action, and then performs the desired action.

### BRIEF DESCRIPTION OF THE DRAWINGS

FIG. 1 illustrates a high-level conceptual diagram of a telecommunications system employing a call challenge device in accordance with one example embodiment of the invention.

FIG. 2 illustrates a call challenge module that may be utilized in accordance with one example embodiment of the invention.

FIG. 3 shows a determination module that may be utilized in accordance with one example embodiment of the invention.

FIG. 4 illustrates a flowchart diagram that illustrates a method of operation in accordance with one example embodiment of the invention.

FIG. 5 illustrates a flowchart diagram that illustrates a method of operation in accordance with one example embodiment of the invention.

FIG. 6 illustrates a block diagram of a call challenge device in accordance with an example embodiment of the invention.

FIG. 7 illustrates a user interface in accordance with one example embodiment of the invention.

FIG. 8 illustrates a block diagram of a call challenge device in accordance with an example embodiment of the invention.

FIG. 9 illustrates a high-level conceptual diagram of a telecommunications system and network in accordance with one example embodiment of the invention.

### DESCRIPTION OF EXAMPLE EMBODIMENTS

The example embodiments described below provide a way to challenge an incoming call of a calling party prior to ringing the ringer of a called party. In accordance with particular embodiments, a call challenge module may be configured to challenge incoming telephone calls based upon the local time of the called party and/or other criteria, such as the occurrence of a particular event such as when a particular television program is being watched by a user. In order to effectuate call challenging, the call challenge module may maintain call challenge rules defining when an incoming call will be challenged, challenge calls accordingly, and take an appropriate action in accordance with a response of the challenged party.

In the following description, specific details are set forth, such as device types, system configurations, protocols, applications, methods, etc., in order to provide a thorough understanding of the present invention. However, persons having ordinary skill in the relevant arts will appreciate that these specific details may not be needed to practice the present invention.

The figures illustrate examples of the invention and the operation of such examples. In the figures, the size of the boxes is not intended to represent the size of the various physical components. Only those parts that are necessary to convey an understanding of an example to those skilled in the art are shown and described. Parts and elements not shown are conventional and known in the art. In situations where an element appears in multiple figures, the same reference numeral is used to denote the same element in each of the multiple figures.

Reference is made to the accompanying drawings which illustrate several embodiments. It is understood that other embodiments may be utilized, and mechanical, compositional, structural, electrical, and operational changes may be made without departing from the spirit and scope of the present disclosure. The specific example embodiments are described herein in a context in which the called party employs a Voice over Internet Protocol (VoIP) system with an associated call manager such as an MTA or VoIP adapter; however, it should be understood that other embodiments are possible using other types of telephone systems.

Some portions of the detailed description which follows may be presented in terms of procedures, steps, logic blocks, processing, and other symbolic representations of operations on data bits that can be performed on computer memory. Each step may be performed by hardware, software, firmware, or combinations thereof.

As used herein, the singular forms “a”, “an” and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

It is noted that telephone calls are placed to particular telephone numbers (that is to particular telephone devices) and not to specific individuals. For purposes of teaching and not limitation, however, herein the term “called party” will be used to mean a particular target telephone with a particular telephone number. That is, as used herein, the term “called party” does not refer to an individual; instead it refers to a particular telephone and the user of that particular telephone. The term “calling party” or “caller” refers to the particular telephone and user of the particular telephone that initiates a communication with the called party.

In a typical telephone call, a calling party places a call to a called party to ring the ringer of the called party's telephone. Oftentimes, a calling party does not know the geographic location or local time of the called party. In the past, area codes were allocated based upon geographic location and therefore a calling party could determine the local time of the called party with reasonable accuracy using the called party's area code. Area codes are no longer a reliable indicator of a called party's location or local time, however, as telephone numbers are assigned to mobile telephones and telephone equipment, such as VoIP adapters, that may be located in areas not traditionally associated with their assigned area code. For example, a VoIP adapter may be used anywhere in the world in which it is connected to an internet connection.

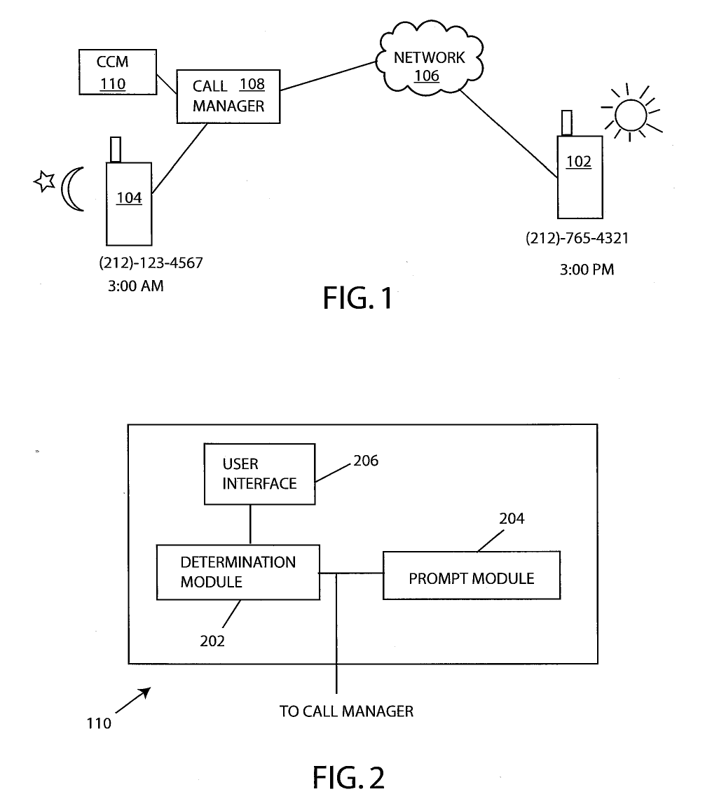

An overall diagram of a first embodiment of the invention is shown in FIG. 1. In the example of FIG. 1, a calling party 102 initiates a telephone call over a network 106 to a called party 104. The called party 104 has a call manager 108, such as a VoIP phone adapter, media terminal adapter (MTA), or other device, that manages calls associated with the called party's telephone number and provides call services such as call waiting, voice mail, call forwarding, and other features. The network 106 is shown in simplified form and may include various subnetworks, gateways, and other known network features known in the art. For example, the network 106 may include the Public Switched Telephone Network, a cell phone network, a wide area network, the public internet, a private internet network, a cable network, a packet-based network, and other networks (not shown) that may include a variety of features such as voice mail servers, time servers, etc.

In this example embodiment, although both the calling party 102 and the called party 104 have the same (212) area code, they are in different geographic locations and different time zones. The local time of the calling party 102 is 3:00 PM and the local time of the called party 104 is 3:00 AM. In a conventional system, if the calling party 102 (not knowing the local time of the called party 104) initiates a call to the called party 104, then the called party's ringer will be rung, even though it is 3:00 AM local time. Unless it is an emergency, this is likely an inappropriate time to ring the called party's ringer.

As seen in FIG. 1, to avoid the unwanted situation of ringing the called party's ringer at an inappropriate time, a Call Challenge Module (CCM) 110 is provided to challenge the called party's 104 incoming calls. In contrast to the above-described conventional response prior to ringing the ringer of the called party 104, the CCM 110 determines whether the incoming call falls within predetermined call challenge rules. For example, the call challenge rules may specify to challenge incoming calls that occur within a particular local time block, referred to as the call challenge time window. If an incoming call does fall within the call challenge rules, then prior to ringing the ringer of the called party 104, the CCM 110 challenges the calling party 102 and prompts the calling party 102 whether to ring the called party's ringer. For example, the CCM 110 may notify the calling party 102 of the called party's current local time and prompt the calling party 102 whether to ring the called party's ringer, route the call to voice mail, or perform some other action. The CCM 110 may then ring the called party's ringer, route the call to voice mail, or perform some other action in accordance with the calling party's response to the challenge.

FIG. 2 shows a simplified block diagram of an example embodiment of a Call Challenge Module 110 that may be used for challenging incoming calls to a called party 104. The CCM 110 may include a determination module 202, a prompt module 204, and a user interface 206 which may take the form of a web server. The determination module 202 determines whether to challenge an incoming call and may communicate the telephone system of the called party 104 and direct the telephone system to perform various tasks such as routing the incoming call to a particular destination. For example, the CCM 110 may be coupled to a call manager 108 of the called party 104 and instruct the call manager 108 to route the call to voice mail system or the ring the called party's ringer.

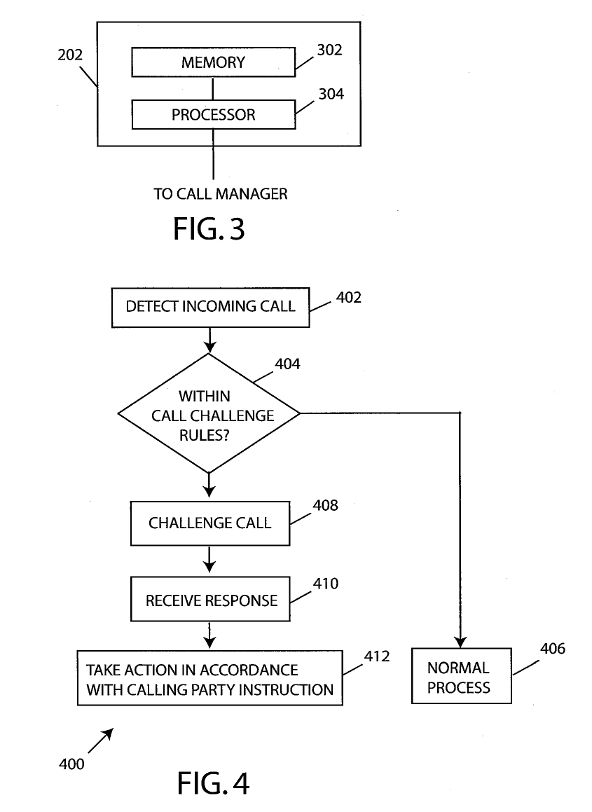

FIG. 3 shows a block diagram of an example embodiment of a determination module 202. As shown in FIG. 3, the determination module 202 may include a memory 302 for storing call challenge rules and a processor 304 for executing actions in accordance with the call challenge rules and sending instructions to a call manager 108 or prompt module 204 to perform various actions. The determination module 202 may also determine the local time of the called party 104. The processor 304 may retrieve call challenge rules stored in the memory 302 and obtain any additional information needed to apply the call challenge rules. For example, where the call challenge rules are based on the local time of the called party and the identity of the calling party, then the processor may determine both the local time and the calling party's identity.

The processor 304 may effectuate its tasks by sending commands to other devices and modules. For example, the processor 304 may a query to a time server to determine the local time, interface with a caller id system to determine the identity of the calling party, send commands to the prompt module 204 to challenge an incoming call, and send commands to the call manager 108 to route the incoming call to voice mail or ring the called party's ringer.

In one embodiment, the processor 304 receives notification of an incoming call from the call manager 108. For example, the call manager 108 may send a notification signal to the processor 304 alerting the processor 304 of the incoming call. The processor 304 may also obtain additional information about the call, such as the calling party's telephone number, area, etc. For example, in a packet switched network, the packets may include information in the headers and fields of the message that may be used by the CCM 110 in determining whether to challenge a call. Using this information the processor 304 may apply the call challenge rules to determine whether the incoming call should be challenged. For example, the processor 304 may issues commands to the call manager as to whether to challenge the incoming call, and if the call is to be challenged, how the call will be challenged and what action to take in accordance with the calling party's response to the challenge. For example, if the call is to be challenged, the processor 304 may instruct the prompt module 204 to notify the calling party of the local time and prompt the user for a response. If the call is not to be challenged, then the processor 304 may simply allow the call to be processed normally, without challenge.

The prompt module 204 may perform challenge duties such as notifying the calling party of the called party's local time, prompting the calling party to specify a desired action, and receiving the calling party's response to the challenge. For example, the prompt module 204 may receive a command from the processor 304 to challenge the incoming call and generate a voice message stating “The local time is 3:00 AM. Press “1” to ring your party or press “2” for voice mail.” The message may be sent to the calling party via the call manager 108. The prompt module 204 may include an automated response system, such as an automated response system capable of interpreting Dual Tone Multi-Frequency (DTMF) TouchTone® tones as known in the art to provide the messaging and response features of the CCM 110. For example, the prompt module may include a file in memory for playback and a related auto response menu to solicit and receive input from the calling party. For example, the response menu may direct the calling party to select a choice from a menu option, such as pressing a key on a touchtone phone or speaking a selection. The calling party's response is received and instructions sent to the call manager 108 to perform an action in accordance with the calling party's response to the challenge.

The CCM 110 may also include a user interface 206 to allow a called party to activate and deactivate call challenging, and update or change the call challenge rules. For example, a web server may be used to generate a website with which a user can interact to set up and change the various settings of the CCM 110. Practitioners in the art will understand that each of the component modules and units shown in FIGS. 2 and 3 may be implemented by hardware, firmware, or software component elements that implement the various functions described herein.

The call challenge rules may be modified to include various criteria for challenging calls, such as the local time of the called party, the identity of the calling party, the area code of the calling party, the day of the week, the occurrence of a particular event, such as the airing of a television show, etc. For example, different call challenge rules may be activated for different days of the week and different call challenge rules can be applied to different calling parties. In an example embodiment, a user may establish a first set of call challenge rules for incoming calls from friends, a second set of challenge rules for work associates, and a third set of challenge rules for others. A user can specify the particular call challenge rules to be applied to a party by associating a telephone number with particular call challenge rules. The identification of a calling party may be determined by traditional caller id functions and call challenge rules that have been specified for that particular party may be applied.

FIG. 4 shows a flowchart of an example method for challenging an incoming call to a called party 104. At block 402 an incoming call is detected. Prior to ringing the ringer of the called party 104, at block 404 a determination is made whether the incoming call falls within the call challenge rules. If the call does not fall within the call challenge rules, then the call is processed normally by the called party at block 406. For example, the call may be sent to the called party 104 to ring the called party's ringer. If the incoming call does fall within the call challenge rules at block 404, then the call is challenged at block 408. For example, the calling party 102 may be provided with information, such as the current local time of the called party 104, and prompted to specify a desired action. At block 410 the calling party's response to the challenge is received and at block 412 an action is taken in accordance with the calling party's response. For example, the incoming call may be routed to voice mail or to the called party 104 to ring the called party's ringer.

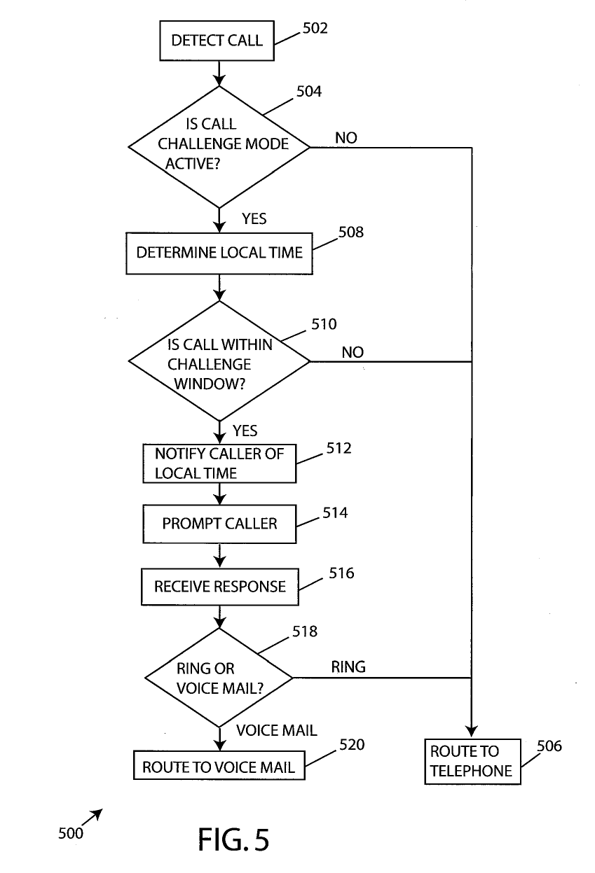

FIG. 5 shows a flowchart of an example method of the invention in which the call challenge rules are based on the local time of the called party 104. Most of the steps and functions shown in FIG. 5 may be performed by the call challenge module (CCM) 110 under control of the call challenge rules located in the memory 302 of CCM 110. As discussed further below, some of the steps and functions may be performed by other components, such as a call manager 108 under the direction of the CCM 110. The operation begins at block 502 by detecting an incoming call from a calling party. The incoming call may be received by a call manager 108 and a call notification sent to the CCM 110. The call notification may be an electrical signal or some other signal.

At block 504 a determination is made whether the call challenge mode is active. For example, a user may activate or deactivate the challenge mode. A user may desire to deactivate the call challenge mode when in a geographic location that corresponds to the traditional area code of the called party's telephone number, in which case it is less likely that calls will occur at inappropriate times, and activate the call challenge mode when in locations or time zones not typically associated with the called party's area code. If the call challenge mode is not active, then the call is processed normally and routed to the called party's telephone at block 506 to ring the called party's ringer. For example, the CCM 110 may send an instruction to the call manager 108 to process the call as normal without challenge.

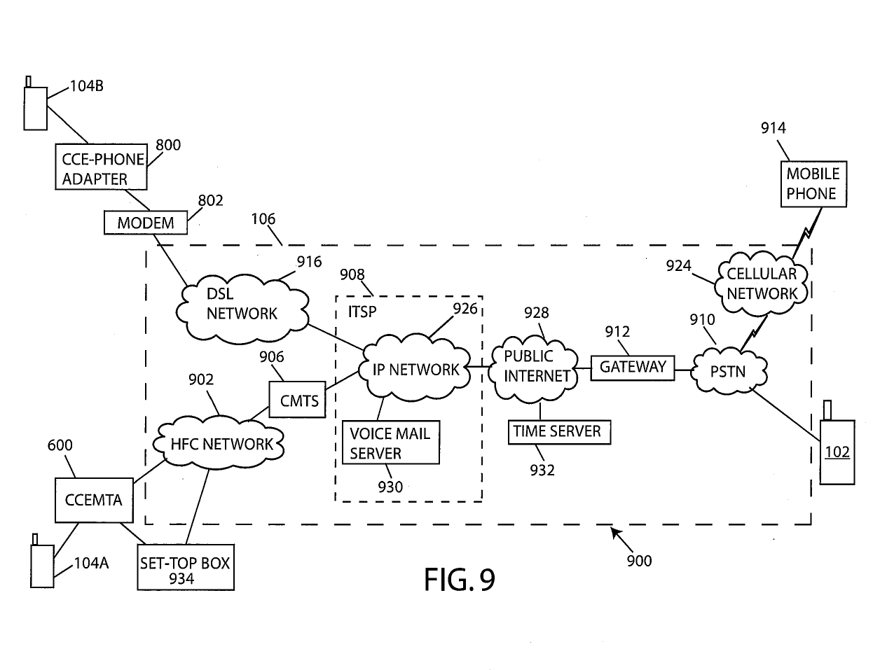

If the CCM 110 is active, then at block 508 the local time of the called party is determined. For example, the CCM 110 may send a request to a time server on the called party's network and receive a response from the time server. For example, in the case where the called party employs a VoIP phone system, the CCM 110 may send a request to a time server 932 (FIG. 9) on the internet, such as a NIST Internet Time Server, to obtain the local time, as known in the art, or send a request to the eMTA or VoIP adapter to do so. Several other methods could be used to determine the local time, such as, by way of example and not limitation, querying an attached computer or other device that has a clock with the associated local time.

At block 510 a determination is made as to whether the incoming call falls within the challenge rules, i.e., whether the incoming call occurs within the call challenge time window. If the call does not fall within the call challenge time window, then the call is not challenged, and is routed to the called party's telephone at block 506 to be processed normally by the called party's phone system and ring the called party's ringer. For example, the call determination module may send a message to the call manager 108 of the called party 104 to process the call as normal and route the call to the called party 104.

If the incoming call falls within the specified call challenge window, then instead of processing the call normally and ringing the called party's ringer, the calling party 102 is notified of the called party's local time at block 512. For example, the CCM 110 may direct the call manager 108 to await further instructions from the CCM 110 on where to route the call and send a message to the calling party 104 notifying the calling party 102 of the current local time. For example, an Automated Response System of the CCM 110 may generate and send a voice message to the calling party stating “The local time is 3:00 AM.”

At block 514 the calling party may be prompted to specify a desired action. For example, a voice message may be sent to the calling party 102 prompting the calling party 102 to “Press one to ring the ringer of the called party. Press two for voice mail.” Although in FIG. 5 the notification message at block 512 and the prompt at block 514 are shown as different messages, a single message could be sent that includes both the local time and the prompt. In this example, the calling party is prompted to press a key of a touchtone telephone to select a desired action, but other means may be provided to allow a user to respond to the prompt, such as speech recognition means to receive a voice from the calling party 102.

The calling party's response to the prompt is received at block 516. At block 518 the calling party's response is determined and if the calling party selects voice mail, then the call is routed to voice mail at block 520. If the calling party selects to ring the ringer, then the call is routed to the called party at block 506. It should be noted that the term “route” as used herein may include establishing a communication session in a variety of ways such as sending voice packets, or establishing an analog voice connection over a RJ11 telephone interface in the case of routing to the telephone.

At block 502 the CCM 110 may be provided with additional information about the incoming call such as the identification of the calling party 102, or the calling party's telephone number or area code. This information can be used in determining whether to challenge the incoming call. For example, a user may designate that incoming calls with designated area codes or telephone numbers be given immunity from challenge. The telephone number of an incoming call and the identity of a calling party may be determined by a conventional caller ID function and provided to the CCM 110.

In the example embodiment discussed above, the CCM 110 was shown as a separate module that is coupled to a call manager 108. This would allow for easy installation with existing call managers. For example, an interface may be provided for coupling the CCM 110 to an existing MTA or VoIP adapter. The CCM 110 may also be incorporated directly into a call manager device 108 to form a Call Challenge Enabled Call Manager (CCCM).

In FIG. 1, the CCM 110 is shown coupled to a call manager 108 that manages calls of the called party 104 over network 106. In other example embodiments, the CCM 110 may be incorporated into a call manager device 108, the particular call manager device 108 depending upon the network used by the called party 104.

For example, in the case where the called party 104 uses a VoIP phone system, the call manager may take the form of a VoIP adapter. VoIP telephony is a packet-switched based technology in which the VoIP adapter manages packets for transmission over the internet. Incoming calls to the called party 104 are received and processed by the VoIP adapter prior to ringing the ringer of the called party 104. A VoIP adapter is typically used in conjunction with a modem connected to a broadband internet connection, and a typical VoIP adapter may include amplifiers, processors, routers, dsps, codecs and other components for managing VoIP phone calls and performing various processing such as compression, noise cancellation, echo cancellation and other signal processing functions. A VoIP adapter may be installed at a cable subscriber's premises to provide an interface between a cable subscriber's analog phone and an IP network.

VoIP adapters may be used in conjunction with various networks such as DSL networks, cable networks, or other IP networks such as corporate or wireless networks. VoIP adapters that are used with networks other than cable networks, such as DSL networks, are typically used in conjunction with an external modem. One such VoIP adapter is the Vonage® PAP2 Phone Adapter made by Linksys. A type of VoIP adapter that is adapted for use with a cable system is a MTA. Such devices are known in the art, such as a PacketCable™ capable Linksys SIP MTA model. MTAs may incorporate a VoIP adapter and a cable modem into a single device, known as an EMTA, such as Scientific Atlanta's WebSTAR™ DPX2213™ Cable Modem with Embedded MTA. Standards have been developed for MTAs such as DOCSIS versions and PacketCable from CableLabs to deliver advanced real-time multimedia services and IP telephony over a two-way cable plant.

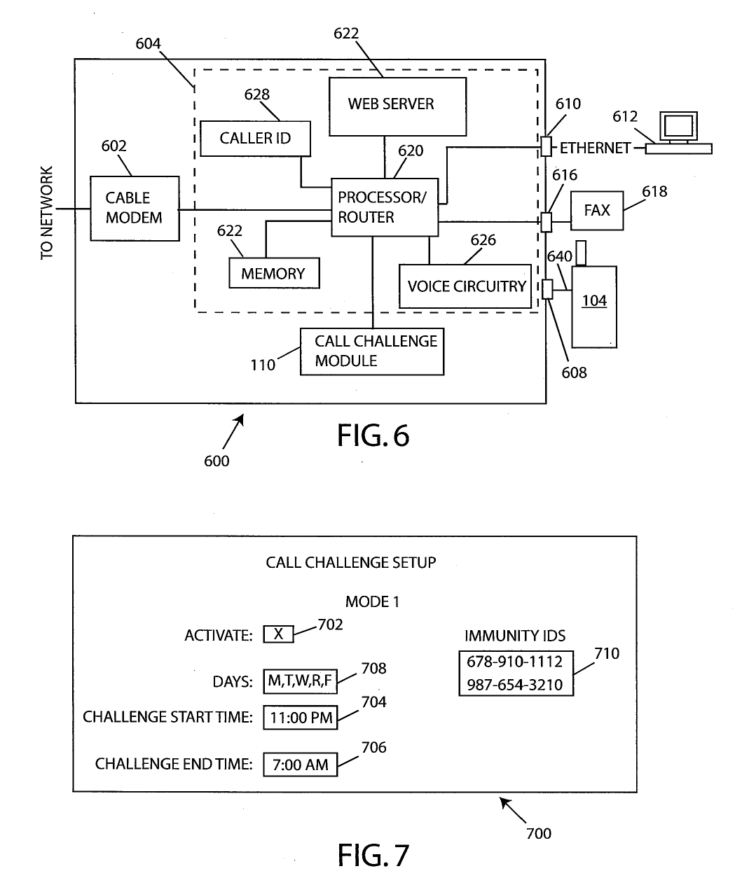

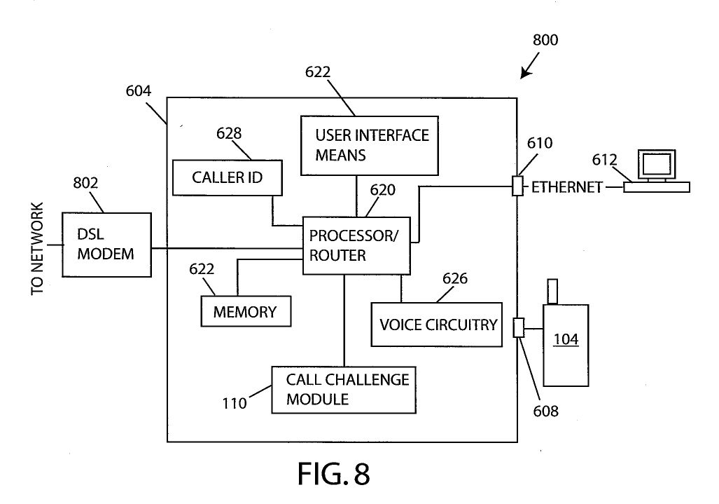

FIG. 6 shows an example embodiment of a Call Challenge Enabled Call Manager in the form of a call challenge-enabled media termination device (CCMTA) 600 that is coupled to a called party's telephone 104. The CCMTA may include a cable modem 602 for sending and receiving data over a HFC cable network 902 (FIG. 9) and a VoIP adapter 604 for providing VoIP functions. The CCMTA 600 may have one or more ports, such as a RJ-11 POTS port 608 for connection to a standard telephone 104, an Ethernet port 610 for connection to a computer 612, and a fax port 616 for connection to a fax machine 618, etc. The CCMTA 600 provides the phone 104 with VoIP capability to communicate over the cable network 902 provided by a cable operator and the IP network 926 provided by the ITSP, as well as additional networks. In this example, the telephone 104 is coupled to the CCMTA 600 by a standard analog phone line through port 608 for PacketCable Voice over IP (VoIP) or Session Initiation Protocol (SIP) communications depending upon the capability of the CCMTA 600. SIP is an application-layer protocol that can establish, modify and terminate multimedia sessions, such as internet telephone, video conferencing, instant messaging, etc. The CCMTA 600 may be SIP capable as defined by the SIP protocol IETF SIP protocol RFC 3261. The IP Network 926 may be capable of executing VoIP call processing applications according to a prescribed VoIP protocol, for example Media Gateway Control Protocol (MGCP) (RFC 2705), Session Initiation Protocol (SIP) (RFC 2543), H.323 protocol, etc. The telephone line 640 may be assigned its own telephone number and incoming telephone calls to that telephone number may be received by the modem 602, processed by the VoIP adapter 604 and routed to the telephone 104. For purposes of teaching, in the example embodiment, the EMTA is shown connecting with a single phone of the called party, but EMTAs may include multiple phone lines as well as additional features such as wireless routing capability.

The cable modem 602 may be a DOCSIS cable modem as known in the art, such as Scientific Atlanta DPC2100 Cable Modem and work in accordance with PacketCable 1.5 and SIP. The VoIP adapter 604 includes components known in the art for performing VoIP functions for processing voice traffic for transmission and reception over cable, such as a processor/router 620 for processing and routing VoIP packets for VoIP calls, a memory 622 for storing instructions and data, a user input means 624 to allow a user to update and change settings of the CCMTA, voice circuitry 626, such as digital signal processors, codecs, etc. for processing voice calls, and a caller id module 628 to identify incoming calls, all of which may be coupled to the processor/router 620. Other components such as a power supply and firewall as known in the art may also be provided but are not shown. The CCMTA 600 may also contain components that operate as a SIP proxy server and media proxy server. In addition, the example embodiment includes a Call Challenge Module 110 coupled to the processor/router 620 to enable the challenging of incoming calls.

In the example embodiment shown in FIG. 6, the CCM 110 interacts with the VoIP module 604 of the CCMTA 600 to effectuate call challenging. It should be noted that some components shown as part of the CCM 110 in FIGS. 2 and 3 could be performed by similar components of the VoIP adapter 604. In addition, although the modem 602 is shown as part of the CCMTA 600 in FIG. 6, it will be understood that external modems may be used, such as in the case where the Call Challenge Enabled VoIP Adapter (CCVA) 800 is used in conjunction with a DSL modem 802. It will be understood that the arrangement shown in FIG. 6 is merely exemplary and other variations are possible.

The user interface may be in the form of a web server 630 that generates a web page that is accessible by a user via a web-accessible communications device, such as a computer 612. In that case, the VoIP user interface may be used to change the settings of the Call Challenge Module 110. Furthermore, the challenge rules may be stored in the memory 622 of the VoIP adapter portion 604. At setup, challenge rules may be established for each telephone line controlled by the CCMTA 600. As discussed above, the challenge rules dictate how the calls to a particular line are to be challenged.

In the example embodiment of FIG. 6, a webserver 630 of the VoIP adapter 604 generates a web page that a user may access by opening a web browser on a computer 612 coupled to the CCMTA 600 and entering the IP address of the CCMTA 600. The web interface may allow a user to change or update various settings of the CCMTA 600, such as set up various IP addresses, protocols, route, etc. and update the challenge rules.

An incoming call received by the cable modem 602 is sent to the VoIP Adapter 604 for processing and routing. The CCM 110 may be alerted to the call and determine whether to challenge the call based upon the call challenge rules. For example, the processor 620 of the VoIP adapter 604 may send a notification signal to the CCM 110 notifying the CCM 110 of the incoming call. The CCM 110 may then determine the local time of the called party, as discussed above. For example, the CCM 110 may send a request to a time server 932 (FIG. 9) shown on public internet 928 to obtain the current local time. Alternatively, the CCM 110 may obtain the local time from a clock (not shown) of the VoIP adapter 604 or from an external device coupled to the CCMTA 600 such as the computer 612.

If the incoming call occurs within the call challenge window, then the CCM 110 challenges the incoming call. For example, the CCM 110 may send a voice message to the calling party 102 notifying the calling party 102 of the local time of the called party 104 and prompting the calling party 104 to specify an action to be taken, such as ringing the called party or being routed to voice mail. The CCM 100 receives the calling party's response and either has the call routed to the phone 104 or to voice mail. For example, the CCM 110 may send an instruction to the processor/router 620 to route the call to voice mail or send the call to the phone 104 to ring the ringer.

For clarity, the CCM 110 in FIG. 6 is shown as a separate module from the VoIP adapter 604 of the CCMTA 600. The functions of the CCM 110 may, however, be incorporated into the VoIP adapter 604. The call challenge rules may be stored in memory 622 of VoIP adapter and actions executed by a processor 620 of the VoIP adapter 604.

FIG. 7 shows an example embodiment of a web page 700 generated by the web server 630 to allow a user to update the settings of the call challenge module 110. An activation box 702 is provided to activate or deactivate the call challenging system and update the call challenge rules. A user may establish a call challenge time window based on the local time of the called party by using a challenge start time field 704 and a challenge end time field 706. In this example, incoming calls will be challenged between 11:00 PM and 7:00 AM. A box 708 may also be provided for specifying the days of the week. For example, different call challenge rules may be applied on weekend days than work days. Different call challenge rules may also be applied to different calling parties. For example, a field 710 may be provided to allow a user to enter telephone numbers that have “immunity” and will not be challenged. For example, a user may allow a spouse or other important person to call without being challenged. Other fields could be provided to set additional call challenge parameters. In addition a user may define sets of call challenge rules. For example, a first set of call challenge rules may be applied to a first group of contacts and a second set of challenge rules may be applied to a second group of contacts. In an example embodiment, a user may specify a first set of challenge rules for incoming calls from friends, a second set of challenge rules for work associates, and a third set of challenge rules for others. A user can specify the particular call challenge rules by associating a telephone number with particular call challenge rules. Once the identity of the party is established, by traditional caller id function for example, the proper call challenge rules may be applied.

FIG. 9 shows an example embodiment of a system 900 of the invention in which a first called party 104A uses a call challenge enabled CCMTA 600 of FIG. 6 and a second called party 104B uses a CCVA 800. A Hybrid-Fiber-Coax (HFC) network 902 provides a communication link between the first called party 104A and an IP network 926 such as a network provided by an Internet Telephone Service Provider (ITSP) 908 or the public Internet 928. Telephony communication using Internet Protocol packets can be transmitted across the Hybrid-Fiber-Coax network 902 between the called party 104 and the Internet 928. For example, a DOCSIS specification (defined by CableLabs) may specify the set of protocols that must be used to effect data transfer across the Hybrid-Fiber-Coax network 902. A cable modem 602 coupled to the called party's telephone 104 by the CCMTA 600 and a Cable Modem Termination System (CMTS) 906 positioned in the head end of the cable system allow the data transfer over the HFC network 902.

In the example embodiment shown in FIG. 9 an ITSP 908 provides a connection between the Public Switched Telephone Network 910 and a packet-based network, such as the public internet 928. A PSTN gateway 912 may terminate calls originating from telephone 102 and mobile telephone 914 on the PSTN 910 to target a called party 104A on HFC network 902 or a called party 104B on DSL network 916. A cable modem 602 within the CCMTA 600 provides an interface to the internet for telephone device 104A and a DSL modem 802 provides an interface to the internet for telephone device 104B.

Voicemail services may be provided by the ITSP via a mail server 930 or from a separate voicemail service provider, such as an Internet Voice Mail Service Provider (not shown). For example, an incoming call to a called party 104 may be transferred to a voice mail server 930 by the CCMTA 600 or CCVA 800. The local time of the called party may be determined from a time server 932 on the internet 928 as known in the art. For example, the CCMTA 600 or the CCVA 800 may query the time server 932 to obtain the called party's 104 local time. The ITSP 908 may include PSTN gateways 912, which provide PSTN termination services. The CCMTA 600 may route calls received from the ITSP 908 to the called party 104A.

The network 106 may include various subnetworks, including, but not limited to, public internet 928, cellular telephone network 924, PSTN 910, managed IP network 926, hybrid fiber coaxial (“HFC”) cable network 902, and DSL network 916. The various subnetworks are typically interconnected as shown in the figure, but other connection architectures are possible. For example, called party 104A is shown connected to public internet 928 via managed IP network 926 and HFC network 902. However, other communication means between the called party 104 and the calling party 102 are possible. Furthermore, if other types of networks are used in place of the HFC network 902, then components, such as CMTS 906 may not be used.

Cellular network 924 may include one or more cell towers (not shown), which transmit and receive signals between the cellular network 924 and wireless subscriber devices, such as, for example a cellular telephone 914, as known in the art. Cellular network 924 is typically coupled to PSTN 910, which may be coupled to managed IP network 926, as known in the art.

When a calling party 102 calls the telephone number of the first called party 104A associated with the CCMTA 600 device coupled to the called party 104A, the call is processed as any call received at an EMTA would be. However, before the call is routed to the POTS telephone device 104 to ring the ringer, the CCM 110 within the CCMTA or CCVA determines whether to challenge the incoming call, based upon the call challenge rules. The determination may be made by identifying the local time of the called party and the comparing the local time with the call challenge rules. Upon determining that the call should be challenged, the call is challenged by sending a message over the network 106 and related subnetworks to the calling party 102. For example, a message may be sent notifying the calling party 102 of the local time of the called party 104 and prompting the calling party to press a button on the calling party's phone, speak a response, or otherwise indicate whether the calling party wants to ring the ringer of the called party or be routed to voice mail. If the calling party desired to ring the called party, then the call is forwarded to ring the EMTA-coupled POTS device 104. If not, then the call is routed to the voice mail server 930 of the service provider, as known in the art. If the calling party does not make a selection, then a default operation may be taken such as routing the calling party to voice mail. The default option can be established at system set up time. Thus, the called party will not be bothered by the ringing of the ringer by unimportant calls that are made at inappropriate times while still being alerted by the ringer by important calls. The CCM 110 provides added functionality without requiring network service providers to purchase new equipment or make other changes to existing procedures, as the CCM can be implemented at the called party's MTA or VoIP adapter.

There may be times when a party does not want to be disturbed by the ringing of a telephone, that correspond with the occurrence of a particular event, such as the airing of a favorite television program. The call challenge rules can be updated in accordance with the called party's viewing preferences. For example, the call-challenging functions of a CCM could be used in conjunction with a cable program guide of a cable set-top box to challenge incoming calls during the particular program. For example, a user could use the program guide to specify a favorite weekly television show and information regarding the show, such as its scheduled air time, could be provided to the CCM. The CCM could then specify a call-challenge window during the show's schedule time. For example, a black out period could be scheduled every Thursday between 9:00 PM and 10:00 PM local time when the user's favorite show is aired.

There also may be times when a user wants incoming calls to be challenged regardless of the local time, such as upon the occurrence of a particular event or during a particular event. For example, a called party may not want to be disturbed during a television program that he has selected using a program guide of a set-top box, regardless of the local time. The CCM may include instructions to challenge incoming telephone calls, or automatically send incoming calls to voice mail, upon the occurrence of particular events, such as when user selects to view a video-on-demand program using a program guide. The program guide could inform the CCM of the selection and the CCM could open a call challenge window while the program is played.

As shown in FIG. 9, a set-top box 934 provided with an interactive program guide capability is communicatively coupled to a CCM, such as the CCEMTA 600, and a HFC network 902. The set-top box may also be an IPTV set-top box with an interactive program guide for use in a data network. The set-top box 934 may send a signal to the CCEMTA 600 upon the occurrence of a particular event and provide the CCEMTA 600 with information regarding the event, and the CCEMTA 600 may use the information to challenge incoming calls in accordance with the call challenge rules. For example, when a user uses the program guide to schedule the recording or a reminder of a particular program, the program guide may send this information to the CCM to update the call challenge rules to challenge calls during the scheduled time and thereby establish a call challenge window for the time that the program will be aired. A call challenge window may be established to correspond with a single occurrence or multiple occurrences/episodes of the program. The call challenge window may also be established based on whether the subscriber is currently viewing a program being recorded.

Likewise, when a user selects a program through a video-on-demand feature or Pay-Per-View, the set-top box 934 may notify the CCM and the CCM may challenge the calls during that program, or in accordance with the particular call challenge rules for that user. Also, the set-top box may send a signal to the CCEMTA 600 upon the occurrence of a subscriber viewing a previously recorded program. In another embodiment, the call challenge window may be modified based upon the length of time the subscriber remains tuned to a particular channel or program or may be modified when the subscriber tunes away from a program such as a program that is being recorded but no longer being viewed. Also, the call challenge window may be modified when the subscriber trick plays a live program or a previously recorded program. For example, when pausing a program the call challenge window may be modified to permit ring of the called party's ringer. If fast forwarding, the call falls within the call challenge window and calls may be routed to voice mail. Thus, the call challenge rules may be updated in accordance with a user's viewing preferences by a program guide, such as that used in a cable set-top box 934.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A method comprising:
determining whether an incoming call from a calling party to a called party falls within predetermined call challenge rules; and
challenging the incoming call if the incoming call falls within the predetermined call challenge rules.

2. The method of claim 1, wherein the step of determining whether an incoming call from a calling party to a called party falls within the predetermined call challenge rules comprises:
determining whether the incoming call falls within a call challenge time window.

3. The method of claim 1, further comprising:
determining the local time of the called party; and
determining whether the incoming call occurs during a predetermined local time call challenge time window.

4. The method of claim 1, wherein the step of challenging an incoming call comprises:
notifying the calling party of the local time of the called party.

5. The method of claim 1, wherein the step of challenging an incoming call to a called party comprises:
notifying the calling party of the local time of the called party prior to ringing a ringer of the called party.

6. The method of claim 1, wherein the step of challenging an incoming call to a called party comprises:
notifying the calling party of the local time of the called party; and
prompting the calling party to specify a desired action.

7. The method of claim 1, wherein the step of challenging an incoming call to a called party comprises:
notifying the calling party of the local time of the called party;
prompting the calling party to specify a desired action; and
performing the desired action.

8. The method of claim 1, wherein the step of challenging an incoming call to a called party comprises:
notifying the calling party of the local time of the called party; and
prompting the calling party to ring a ringer of the called party or route the incoming call to voice mail.

9. The method of claim 8, further comprising ringing a ringer of the called party.

10. The method of claim 8, further comprising, routing the incoming call to voice mail without ringing the ringer of the called party.

11. The method of claim 1, wherein determining whether an incoming call from a calling party to a called party falls within predetermined call challenge rules comprises:
determining the identity of the calling party; and
applying call challenge rules associated with the identity of the calling party.

12. The method of claim 1, further comprising:
updating the predetermined call challenge rules in accordance with the television viewing preferences of the called party.

13. The method of claim 1, wherein the updating step comprises updating the predetermined rules based upon viewing a program that is being recorded.

14. The method of claim 1, further comprising:
determining when a television program will air;
determining whether the incoming call occurs during the television program; and
challenging the incoming call if it occurs during the television program.

15. The method of claim 1, wherein the updating step comprises updating the predetermined rules based upon viewing a program that has been previously recorded.

16. The method of claim 1, wherein the updating step comprises updating the predetermined rules based upon trick play of the television program.

17. An apparatus, comprising:
means for challenging an incoming call from a calling party to a called party in accordance with predetermined call challenge rules.

18. The apparatus of claim 17, wherein said means for challenging an incoming call comprises:
means for determining whether the incoming call falls within the predetermined call challenge rules; and
means for challenging the incoming call if the incoming call falls within the predetermined call challenge rules.

19. The apparatus of claim 18, wherein said means for challenging an incoming call comprises:
means for determining the local time of the called party; and
means for notifying the calling party of the local time prior to ringing a ringer of the called party.

20. The apparatus of claim 18, wherein said means for challenging an incoming call comprises:
means for determining the local time of the called party;
means for notifying the calling party of the local time prior to ringing a ringer of the called party; and
means for prompting the calling party whether to send the incoming call to voice mail or to ring the called party's ringer.

21. The apparatus of claim 17, further comprising:
means for determining the called party's television viewing preferences, wherein said predetermined rules specify challenging calls in accordance with the viewing preferences.

22. The apparatus of claim 17, wherein said means for determining the called party's viewing preferences is a program guide.

23. A system comprising:
a call manager for managing calls of a called party; and
a call challenge module coupled to said call manager, said call challenge module operable to challenge incoming calls that fall within predetermined call challenge rules.

24. The system of claim 23, wherein said call manager comprises a Voice over Internet Protocol (VoIP) adapter.

25. The system of claim 23, wherein said call manager comprises a media terminal adapter (MTA).

26. The system of claim 23, further comprising a program guide updating the call challenge rules in accordance with the selections implemented with the program guide.
